(19) United States
(12) Patent Application Publication
(10) Pub. No.: US 2026/0359898 A1
(43) Pub. Date: Nov. 12, 2026

(54) DATA COMMUNICATIONS NETWORK AND METHOD FOR DOCUMENTING INFORMATION IN RELATION TO ASSETS

(71) Applicant: Sirenture Pty Ltd PL ATF Maison de Valois Family Trust, Botany, New South Wales (AU)

(72) Inventor: Rosie DE VALOIS, Botany (AU)

(21) Appl. No.: 19/489,762

(22) PCT Filed: Jun. 6, 2024
(86) PCT No.: PCT/AU2024/050594

§ 371 Date: Dec. 3, 2025

(30) Foreign Application Priority Data
Jun. 8, 2023 (AU) 2023901811

(51) Int. Cl. G06Q 40/08; G06Q 30/018; G06Q 30/0283

(52) U.S. Cl. CPC G06Q 40/086; G06Q 30/018; G06Q 30/0283

(57) ABSTRACT

The present invention relates to a data communications network and method for documenting detailed information relating to assets. Details are received from each user including verification details sufficient to establish a user account, and details relating to one or more assets of the user. The details are processed and prompts are generated for display on a data communications device of the user requesting specific additional information required to establish or update one or more of a location of each asset, security measures associated therewith, ownership, or a value of each asset. The additional information is received from the user, and the location, security measures, ownership, and value of each of the assets is extracted therefrom and transmitted to an insurance provider upon receipt of an instruction from the user. This enables a quotation to be issued by the insurance provider which the user can accept or reject.

### FIELD OF THE INVENTION

The present invention relates to a data communications network and method for documenting detailed information regarding assets, and is particularly useful in those instances where the assets comprise high value items (eg. jewelry) and there is an event for which an insurance claim will require detailed information regarding items lost, damaged or stolen during the event.

### BACKGROUND OF THE INVENTION

The loss and/or damage of assets due to, for example, theft, flood or fire, can often be a highly stressful time for the owner of such assets when attempting to submit a claim in relation to their insurance policy in order to receive compensation from their insurer.

To submit a claim with respect to an insurance policy in the event of suffering loss, theft and/or damage of assets, the owners of such assets must first provide evidence to their insurer that confirms the existence and ownership of such assets. However, a failure to maintain proper records regarding assets can make this evidentiary process difficult, and at times impossible, thereby often resulting in a rejection of an insurance/compensation claim or a claim payout that is lower than would otherwise be determined if comprehensive records were maintained.

The types of evidence that insurance claim assessors typically rely upon to establish the existence and ownership of assets includes, but is not limited to, sales receipts, photographs, original packaging, certificates of authenticity, original operating manuals, valuations, detailed descriptions, and proof of purchase. However, there is no current system known to the applicant that is able to efficiently document such information in relation to assets, and thereby enable the provision of important information to insurers for the purpose of valuing insurance policies, assessing claims and/or enabling law enforcement agencies to trace lost and/or stolen items.

The present invention seeks to mitigate the problems discussed herein, or at least provide an alternative solution to issues associated with existing networks, systems and/or methods for collecting and documenting asset information.

The reference to any prior art in this specification is not, and should not be taken as, an acknowledgement or any suggestion, that the prior art forms part of the common general knowledge.

### SUMMARY OF THE INVENTION

In one aspect, the present invention provides a data communications network including connected data communications devices and a method of operating same to facilitate the documentation of information relating to assets, the method including, receiving, by one or more processors, details from each user of a plurality of users including verification details sufficient to establish a user account, receiving, by one or more processors, details from each user regarding one or more assets owned by the user, processing, by one or more processors, the details regarding one or more assets owned by the user and generating, for display on a data communications device associated with the user, prompts regarding any specific additional information required to establish or update one or more of, a location of each asset, security measures associated with each asset, ownership of each asset, or a value of each asset, receiving, by one or more processors, additional information from the user in response to the prompts, and extracting from the received details and the additional information received in response to the prompts, the location, security measures present at the location, ownership, and value of each of the one or more assets, transmitting, by one or more processors, the extracted details to an insurance provider upon receipt of an instruction from the user, receiving, by one or more processors, details from the insurance provider including a quotation to insure, or continue to insure, the one or more assets, and receiving, by one or more processors, an acceptance of the quotation from the user confirming that the user considers the quotation acceptable.

In an embodiment, the method further includes transmitting, by one or more processors, the extracted details to a law enforcement agency upon receipt of an instruction from the user.

In an embodiment, the prompts regarding any specific additional information required to establish or update one or more of the location, security measures, ownership, or value of each asset include a request for one or more of, a description of each asset, copies of purchase documents including one or more of invoices, receipts or warranty documents associated with each asset, one or more images or photographs of each asset, relevant information pertaining to each asset including one or more of purchase date, purchase price, and valuation details, or supporting documents including one or more of a certificate of authenticity, certificate of valuation, or technical drawings associated with each asset.

In an embodiment, the location of the one or more assets is determined according to the extracted details regarding the location of the one or more assets, or in instances where the asset is carried by the user, utilising a GPS location facility associated with the user's data communications device.

In an embodiment, the security measures present at the location of the asset include one or more of, installation of security doors, installation of security cameras, installation of security alarms, storage of the asset in a secure environment including one or more of, on the user, in a locked room, in a locked cabinet, or in a safe. It will be appreciated that various security measures such as, for example, the installation of security doors, security cameras and alarms, all contribute to reducing the risk of theft and hence reduces the amount of an insurance quotation, and therefore it is desirable that such information is disclosed to the insurer as soon as any changes to security measures associated with the location at which assets are stored occurs.

In an embodiment, the method further includes, automatically determining, by one or more processors, that information received from a user represents an update to previously received details and information in relation to the asset(s), the updates including any change in respect of one or more of, the asset(s), the ownership of the asset(s), the value of the asset(s), the location at which the asset(s) are maintained, or the security measures at the location at which the asset(s) are maintained.

In an embodiment, the method further includes, extracting the changes to the asset(s), the ownership, the value, the location and/or the security measures, and transmitting same in substantially real-time to the insurance provider. In this regard, it will be appreciated that it is important that insurers are maintained informed regarding any changes to the details and information provided by the user regarding their asserts and circumstances to ensure the user pays the lowest insurance premium possible, and also to avoid any potential cancellation or voiding of their insurance policy that may arise as a result of a change in their circumstances, for example, removal of existing security doors at the time of the insurance policy.

Accordingly, the ability to transmit, substantially in real-time, any changes entered by the user directly to the insurer, by the present system and method, assists to protect the user's interests. It will also be appreciated that the ability to transmit, substantially in real-time, any changes entered by the user directly to the insurer, also avoids the need for the user to separately contact their insurer using, for example, electronic mail or other communication means. This has the technical benefit of conserving computing processing and networking resources as compared with alternative methods regarding communication of changes to an insurance provider.

In an embodiment, the method further includes, receiving, by one or more processors, feedback from the insurance provider that the changes to the asset(s), the ownership, the value, the location and/or security measures requires one or more of, a new insurance policy relating to the one or more assets, an amendment to an existing insurance policy for the one or more assets, or an amendment to the quotation.

In an embodiment, the one or more assets include items of value including one or more of, custom made items, collectables and antiques, jewelry, paintings, sculptures, ceramics, period furniture, clocks, books, maps, stamps, rugs, or tapestries.

In an embodiment, generating prompts regarding any specific additional information required to establish or update one or more of a location of each asset, security measures associated with each asset, ownership of each asset, or a value of each asset, further includes, identifying that the asset represents an item of value and on that basis requesting a more detailed description from the user in support of the asset being categorised as an item of value (eg. its provenance).

In an embodiment, in addition to using received details and additional information from the user regarding each asset to establish or update a value of the asset, the method further includes retrieving further details relating to the one or more assets by one or more of, conducting, by one or more processors, an online search to locate further details regarding the one or more assets according to visual matches with other items located during the online search and extracting said further details from one or more online data repositories and utilising same to establish or update the value of the asset, retrieving, by one or more processors, further details regarding the value of the one or more assets from one or more external data sources, or utilising, by one or more processors, one or more artificial intelligence techniques to perform predictive analytics.

In an embodiment, said further details include one or more of, a catalogue price of the same or a similar asset, a market valuation undertaken in respect of the same or a similar asset, a market value of material of which the asset is comprised (eg. the current value of gold), online auction results in respect of the same or a similar asset, or determined or predicted value trends or patterns with respect to the same or a similar asset.

In an embodiment, the method further includes, automatically transmitting, by one or more processors, the further details relating to the one or more assets to the insurance provider.

In an embodiment, the method further includes, generating, by one or more processors, an interface that enables users to access a catalogue of their one or more assets including data relating to ownership and value of each asset, and the location of the asset(s) and security measures in place to secure the asset(s).

In an embodiment, the method further includes, generating, by one or more processors, information for the user regarding those assets in the catalogue that require regular and/or infrequent maintenance to maintain or enhance the value of the asset, and generating, by one or more processors, notifications to the user requesting that the user attend to one or more actions to maintain or enhance the value of the asset and transmitting the notifications to the user at appropriate times.

In an embodiment, the method further includes automatically providing, by one or more processors, users with regular updates regarding the value of their assets according to their catalogue of items.

In an embodiment, the method further includes, providing, by one or more processors, a communication facility to enable law enforcement agencies and/or insurance providers to request confirmation regarding details received by the law enforcement agencies and/or insurance providers in respect of asset(s) owned by the user.

In an embodiment, the method further includes, generating, by one or more processors, recommendations for the user with respect to increasing security measures for assets including those assets that are recognised as items whose valve will increase over time, and where the current security measures are determined not to satisfy a minimum security threshold for such assets (eg. where security measures are considered either less than adequate or warrant upgrading).

According to another aspect, the present invention provides a computer-implemented method for facilitating the documentation of information relating to assets, the method including, receiving, by one or more processors, details from each user of a plurality of users including verification details sufficient to establish a user account, receiving, by one or more processors, details from each user regarding one or more assets owned by the user, processing, by one or more processors, the details regarding one or more assets owned by the user and generating, for display on a data communications device associated with the user, prompts regarding any specific additional information required to establish or update one or more of a location of each asset, security measures associated with each asset, ownership of each asset, or a value of each asset, receiving, by one or more processors, additional information from the user in response to the prompts, and extracting from the received details and the additional information received in response to the prompts, the location, security measures present at the location, ownership, and value of each of the one or more assets, transmitting, by one or more processors, the extracted details to an insurance provider upon receipt of an instruction from the user, receiving, by one or more processors, details from the insurance provider including a quotation to insure, or continue to insure, the one or more assets; and receiving, by one or more processors, an acceptance of the quotation from the user confirming that the user considers the quotation acceptable.

According to a yet further aspect, the present invention provides a computer-readable medium including computer instruction code that, when executed on a computer, causes one or more processors of the computer to perform the steps of: receiving details from each user of a plurality of users including verification details sufficient to establish a user account, receiving details from each user regarding one or more assets owned by the user, processing the details regarding one or more assets owned by the user and generating, for display on a data communications device associated with the user, prompts regarding any specific additional information required to establish or update one or more of, a location of each asset, security measures associated with each asset, ownership of each asset, or a value of each asset, receiving additional information from the user in response to the prompts, and extracting from the received details and the additional information received in response to the prompts, the location, security measures present at the location, ownership, and value of each of the one or more assets, transmitting the extracted details to an insurance provider upon receipt of an instruction from the user, receiving details from the insurance provider including a quotation to insure, or continue to insure, the one or more assets, and receiving an acceptance of the quotation from the user confirming that the user considers the quotation acceptable.

### BRIEF DESCRIPTION OF THE DRAWINGS

Embodiments of the invention will now be described in further detail with reference to the accompanying Figures in which:

FIG. 1 provides an overview of a data communications network according to an embodiment of the present invention showing, in particular, the interaction between various network components;

FIG. 2 illustrates a diagram associated with an exemplary server component within the network illustrated in FIG. 1;

FIG. 3 illustrates a flow diagram of an exemplary process that enables a user to download and install a software application, and subsequently access, or register to use, the software application for interaction with the network illustrated in FIG. 1, including to upload relevant identification details and to have such details verified;

FIG. 4 illustrates a flow diagram of an exemplary process that enables the user to enter details relating to one or more assets owned by the user including information required to establish a location of the asset(s), ownership and value of the asset(s), and security measures in place to protect the asset(s);

FIG. 5 illustrates a diagram associated with an example interface of the software application that enables the user to select an insurance provider and transmit details relating to their assets to the insurance provider with the ability to receive and accept quotations; and

FIG. 6 illustrates a diagram associated with a further example interface of the software application that enables the transmittal of details relating to stolen assets to a law enforcement agency, and additional functionality that enables asset details to be updated and for updates including with respect to the value of assets to be received.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some features have not been described in detail to avoid obscuring the present disclosure.

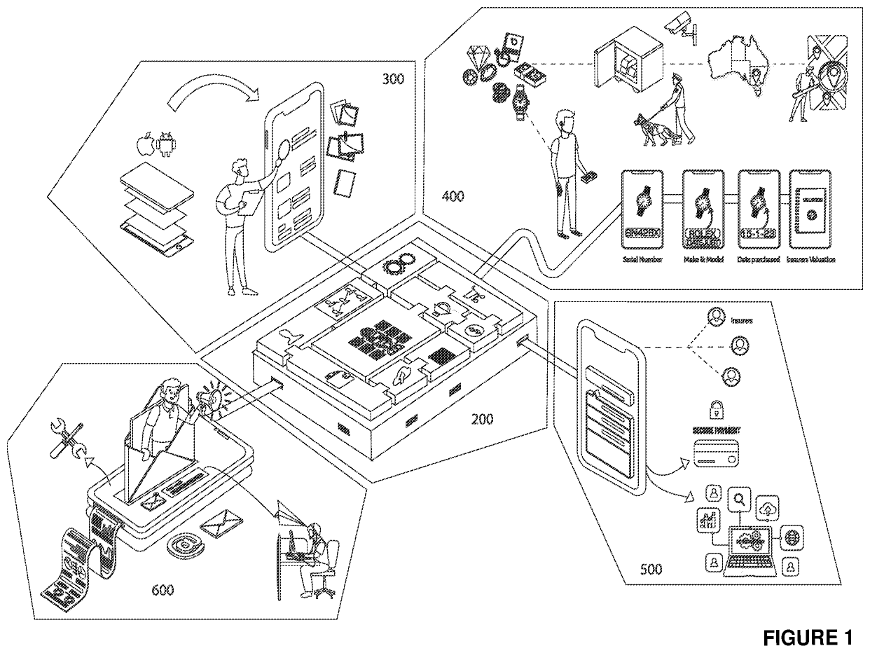

The present invention, according to an embodiment, relates to a computer-implemented data communications network and method that facilitates the documentation of information relating to one or more assets (60) owned by a user (30), as depicted in FIG. 1. The network and method provide a platform that hosts a computer-executable software application (40), wherein the application (40) is accessible by a plurality of such users (30). The platform enables users (30) to not only easily transmit details relating to their assets (60) to one or more insurance providers (80) and law enforcement agencies (90), but to also receive details from the insurer (80) including a quotation to insure, or continue to insure, the asset(s) (60) and to accept or reject the quotation.

According to an embodiment, the platform is provided by a central server (20) which maintains one or more processors and/or databases for performing functions, including receiving details from the user (30) that include details relating to the user (30) sufficient to establish a user account, as well as details regarding one or more assets (60) owned by the user. Prompts are provided to the user (30) regarding specific information (65) required to establish an asset profile including information and documentation (65) relating to ownership and value of the asset (60), information (70) relating to security measures that have been put in place by the user (30) to avoid theft of the asset (60), and a location (75) of the asset (60). In this way, when the user (30) is required to transmit details relating to their assets (60) to an insurance provider (80) and/or law enforcement agency (90) (eg. at regular or predetermined intervals as required by an insurance policy, based on a loss or damage event occurring, etc), the platform may be utilised to quickly and easily transmit the details relating to the user (30) and the profile relating to one or more assets (60) that have been lost or stolen and hence are the subject of the particular enquiry or report being provided to the insurance provider (80) and/or law enforcement agency (90).

Upon establishment of the ownership and value of each of the one or more assets (60), the server (20) is further configured to receive details from an insurer (80) selected by the user (30), including a quotation to insure, or continue to insure, the one or more assets (60). Further, the server (20) is configured to receive an acceptance of the quotation from the user (30) in the event that the user (30) considers the quotation acceptable, or alternatively, a rejection.

The person skilled in the relevant field of technology will appreciate that the platform provides a solution to existing problems associated with collecting and storing necessary information regarding purchased assets (60) that satisfy the requirements of insurance providers (80) and/or law enforcement agencies (90) in the event that an asset (60) is lost or stolen, particularly in instances where the assets (60) comprise high value items such as jewelry, watches, precious stones, bullion and coins. In addition, the network and method provide significant benefits with respect to law enforcement agencies (90) seeking to reduce incidents of fraud and black-market activities in relation to items (60) of significant value. Having collected a significant amount of detail regarding an asset (60) that has been purchased, with significant assistance provided to the user (30) to quickly and conveniently capture and store all such information in the instance of loss or theft, the ability to generate a detailed listing of the affected items and provide same to relevant agencies such as insurance providers (80) and/or law enforcement agencies (90) without delay (in substantially real-time) is of significant benefit to the user and also conserves computing resources.

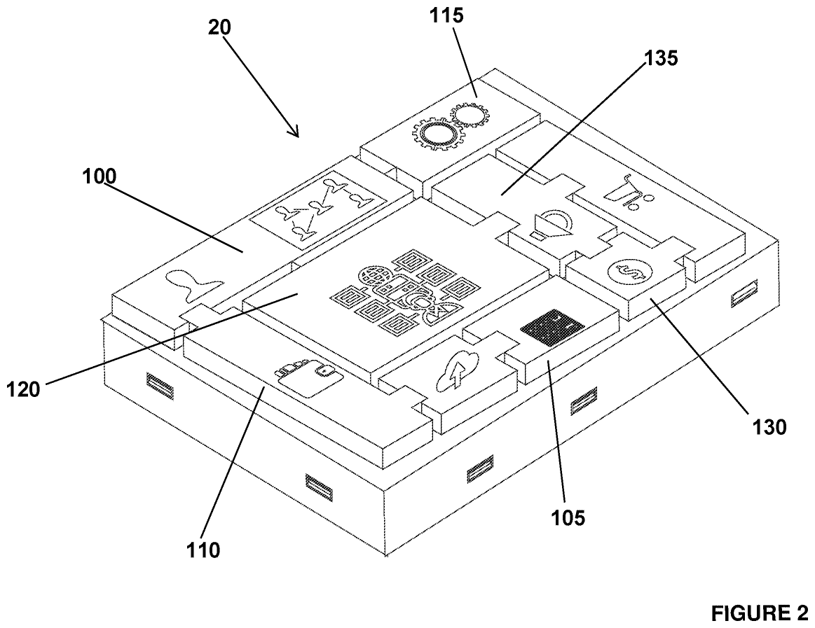

FIG. 1 is divided into segments which are further expanded in subsequent FIGS. 2 to 6. In particular, Segment 200 of FIG. 1 shows the server component (20) with which a software application (40) operating on data communication devices (50) of individual users (30) are configured to communicate. It will be apparent to the person skilled in the relevant field of technology that the software application (40) may be a mobile application or a web application, and similarly, the data communications device (50) utilised by each user (30) may be a portable device such as a mobile phone, tablet or laptop, or a fixed location device such as a workstation or personal computer (not shown). The server component (20) is additionally detailed in FIG. 2.

The skilled person will also appreciate that the steps described herein may be executed by the device (50), wherein such operations are facilitated by the software application (40) operating on each device. According to another implementation of the present invention, the server (20) is programmed to provide most, or all, of the functions described herein particularly where they cannot be provided locally on the user devices (50) or where it may be impractical to do so. In other words, the steps described herein as performed by the device (50), or components thereof, may be associated with hardware that is located externally of the device, such as the remote central server (20) (ie. in a distributed architecture). Different arrangements are possible in this regard, and alternate variations will be apparent to the person skilled in the relevant field of technology.

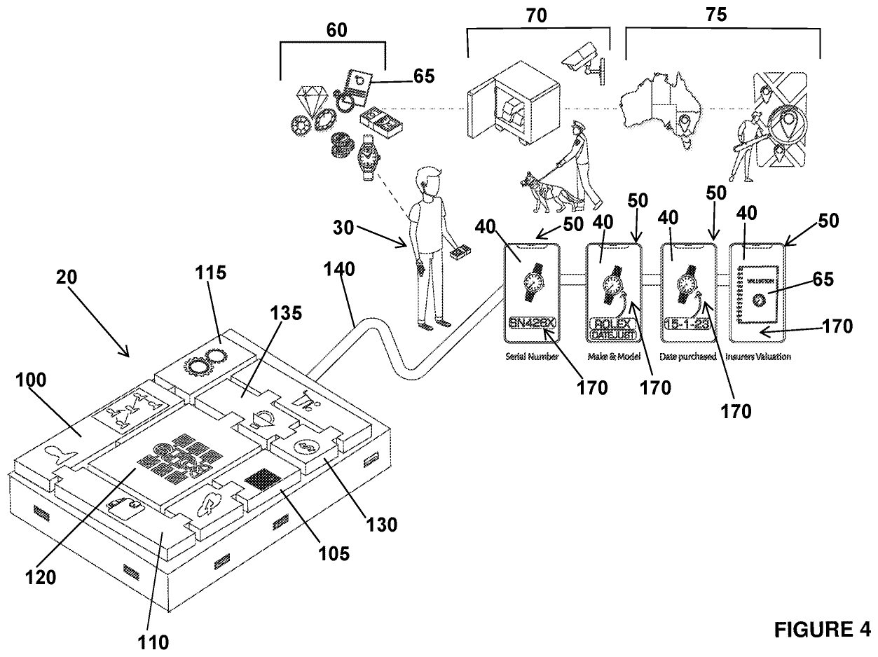

Segment 300 of FIG. 1 shows how the server (20) may be configured for communication (140) with the devices (50) associated with users (30). In one example, the server (20) may receive data from the devices (50) for the purpose of creating a user profile (eg. based upon the entry of details from the user (30)). Segment 300 of FIG. 1 further shows a user (30) downloading and installing the application (40) and subsequently accessing the application (40) to establish a user account and profile, and to enable such details to undergo verification. Segment 400 of FIG. 1 shows example interfaces that enable entry of details relating to one or more assets (60) owned by the user (the particular example illustrating a watch), and specific information required to establish ownership and value of the asset (60), the location of the asset (60), and security measures associated with the asset (60), as further detailed in FIG. 4.

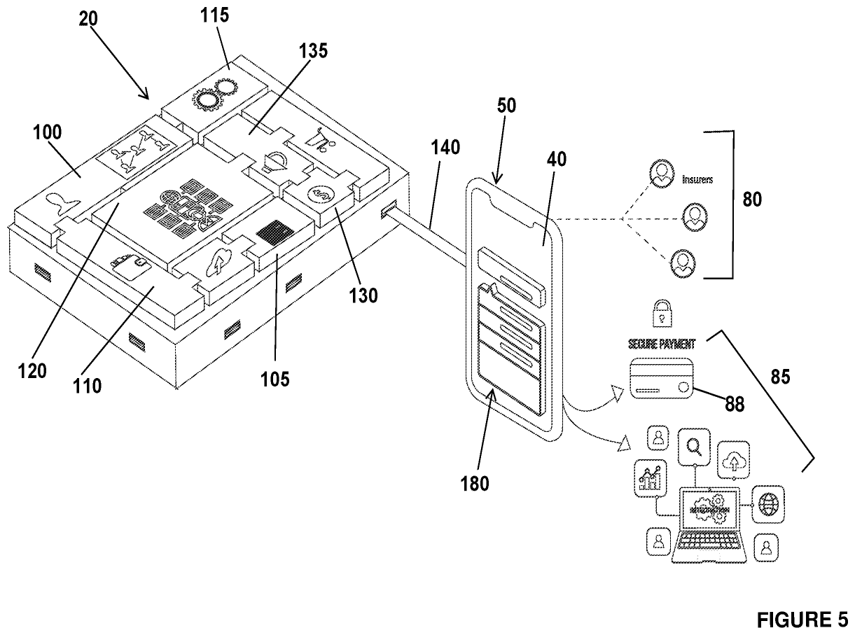

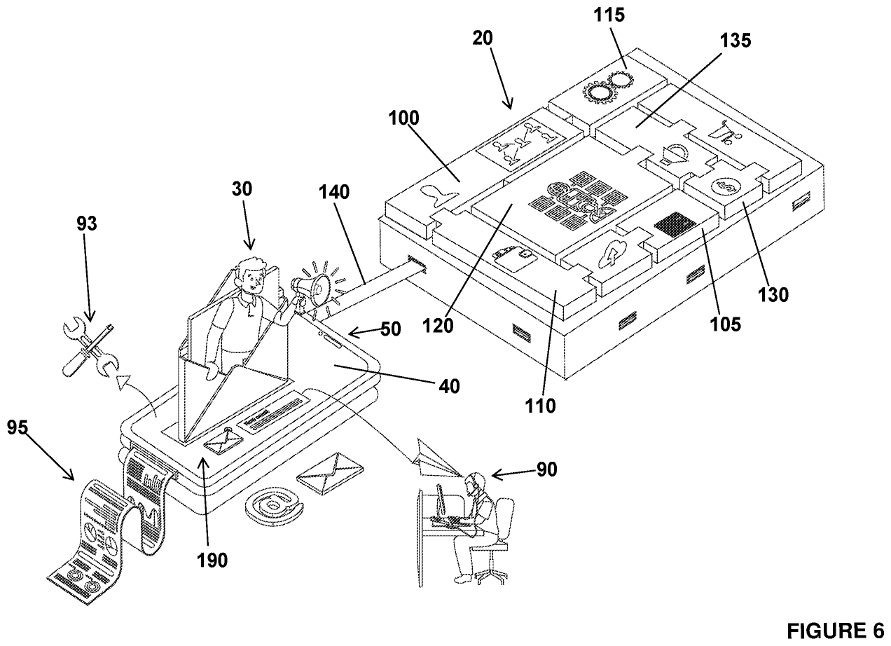

Segment 500 of FIG. 1 shows an additional example interface which allows the user (30) to be provided with a list of insurance providers from which to select a preferred insurance provider (80) and transmit collated details relating to assets (60), including the ability to receive and accept quotations and make payments (85) based on acceptance of quotations, as further detailed in FIG. 5. Segment 600 of FIG. 1 shows a further example interface enabling multiple additional functions including the ability to transfer similar data to a law enforcement agency (90), update asset details including in relation to maintenance/repair (with automatic updates provided to insurers and law enforcement agencies), receive updates with respect of the value of particular assets (60), generate reports, access information in relation to assets (60) including maintenance schedules, and to access a communication facility, as further detailed in FIG. 6.

As mentioned above, FIG. 2 shows in greater detail Segment 200 of FIG. 1, and, in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account register (100) storing details of each user (30) (eg. name, address, contact details, and any additional details which may be relevant for the purpose of identifying each user). Additionally, details relating to any financial accounts held by the user (30) may also be stored in the user account register (100) which may be required to enable payments to insurance providers (80);
Insurance provider/law enforcement agency register (105) storing details relating to a network of registered insurance providers (80) and law enforcement agencies (90). Users (30) may select an insurance provider (80) with a view to engaging the provider (80) to provide insurance with respect to lost, damaged or stolen assets (60), and in the case of theft, seek assistance from a law enforcement agency (90);
Asset register (110) storing details relating to all registered assets (60) associated with users (30) including the information (65) that establishes ownership and/or value of the assets (60) (e.g. serial numbers, make and model, date of purchase, valuations, etc), information (70) relating to security measures associated with each asset (60), and information relating to the location (75) of assets (60). Additional information may be stored in the asset register (110) including details relating to current insurance policies which are in place in respect of assets (60), pending and accepted quotations that have been provided to users (30), details relating to any pending requests for assistance from law enforcement agencies, etc;
Verification functionality (115) for verifying details submitted by users (30) in relation to attributes of the user (30) as well as the information provided in relation to the assets (60) owned by the user (30). Such verification may be assisted with the use of one or more artificial intelligence techniques, eg. using machine learning algorithms to identify and stop fraudulent account establishment, and improving security;
Data processing functionality (120) for processing user input commands and any additional received data for the purpose of generating outputs for display in software application (40). For example, functionality (120) may generate a display that prompts users (30) for information, may process user requests for insurance quotes as well as the receipt and provision of quotes, and may further process quote approvals and communications with insurers (80) and/or law enforcement agencies (90) and with other users (30). The data processing functionality (120) may also be responsible for automatically selecting a subset of insurance providers (80) and/or law enforcement agencies (90) for presentation to a user (30) depending upon particular details submitted and/or preferences selected by the user (30);
Payment gateway functionality (130) for managing all financial transactions that may be required to be effected using the software application (40), including payments from users (30) to particular insurance providers (80) based upon approval of insurance quotations. Additional payments that may be made using the payment gateway includes payment of subscription fees to an administrator of the platform for utilization of the software application (40); and
Notification/Alert functionality (135) responsible for generating and providing particular notifications and/or alerts to users (30) including based on the receipt of valuation updates with respect to their assets (60), notifications regarding acceptance or rejection of particular insurance claims, notification of receipt of communications from other users (30), insurance providers (80) or a law enforcement agents (90).

FIG. 2 also depicts that server (20) is configured to enable communication (140) with the devices (50) and, in particular, the software application (40) operating on each device (50). Such communications may occur via the internet or similar communications network.

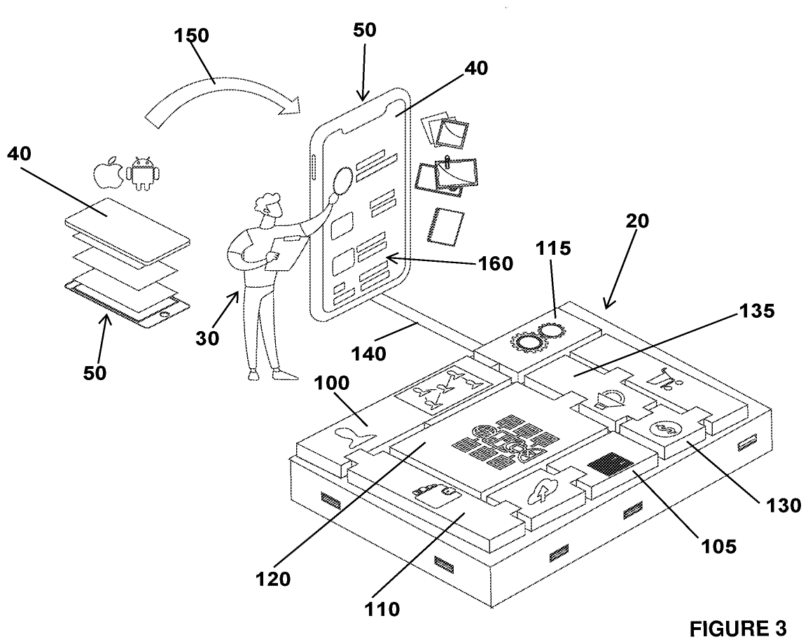

FIG. 3 shows in greater detail Segment 300 of FIG. 1 and, in particular, the steps associated with a user (30) installing (150) the software application (40) on their device (50), and subsequently accessing a user login and registration interface (160) associated with the application (40). Such access may be granted after the user (30) has installed the application (40), which may be achieved by downloading the application (40) from an application store. Each user (30) may create an account (which may include a user profile) using the application (40) and the account/profile information may be stored in the user account register (100).

The interface (160) may also prompt the user (30) for any information that has not been provided as part of the registration process but which may be required in order to verify the user (30). Full access to the software application (40) may be prevented pending the receipt of all such necessary information and/or documentation. The server (20) may utilise, or send instructions to an external provider to utilise, one or more verification techniques including one or more artificial intelligence techniques to verify particular information submitted by the user (30) including in relation to the user's own details and attributes such as name, age, address, etc. For example, information submitted by a user (30) may be compared against information that may be accessed from one or more trusted public registers.

FIG. 4 shows in greater detail Segment 400 of FIG. 1 and, in particular, the use of an interface (170) by a user (30) to upload relevant details relating to one or more assets (60) owned by the user (30). In the particular example shown, the asset (60) is a watch and the reader will appreciate that a series of interfaces (170) are illustrated in which the user (30) is prompted to enter information relating to the watch such as a serial number, make and model, date of purchase and a valuation associated with the particular asset. It is to be understood that the information requested may be different for different assets (60) and the software application (40) will have the ability to recognize a particular asset (60) registered by the user (30) and generate relevant interfaces and prompts that request particular information relevant to the particular asset (60). In a preferred embodiment, document scanning techniques combined with image recognition methods including artificial intelligence techniques are used to facilitate the upload of asset information and the combined implementation of these techniques to the task of extracting and uploading information relevant to a user's assets significantly reduces the complexity of the task associated with uploading relevant details relating to one or more assets (60) owned by the user (30).

In order to establish a complete profile for each asset (60) associated with the user (30), the user (30) will be requested to provide additional information associated with the asset including information (65) sufficient to establish ownership and a value of the asset (60) (eg. any one or more textual items providing a brief description of the asset, copies of purchase documents, receipts, warranty documents, etc, one or more images/photographs of the item (60), relevant dates pertaining to the item of value including the purchase price, valuation details, etc and any other supporting documents such as certificates of authenticity, valuation and/or technical drawings regarding custom-made items of value). Further, the interface (170) may prompt the user (30) to enter details (70) relating to safety measures taken by the user (30) to protect the particular asset (60) (eg. the item may be held in a safe, be under constant video surveillance, etc). The interface (170) will also prompt the user (30) to enter the location (75) of the particular asset (60) which may include the address at which the item is located, and map functionality that enables the user to provide additional location details. All information and/or documentation is subsequently stored by the server (20) and indexed such that when such information is required to be extracted and submitted to a particular insurance provider (80) and/or law enforcement agency (90), the information and documentation may be quickly and efficiently extracted based upon being indexed in association with the particular user (30) who owns the asset(s) (60).

Where information may be obtained automatically, a prompt need not be generated for entry of such information. For example, the location of the particular asset (60) may be automatically ascertained based upon the address of the user (30), or if the asset is worn by the user (30) the location (75) may be obtained based upon a GPS location associated with the user's device (50). One or more artificial intelligence techniques may also be utilized to extract and automatically populate such information. In these circumstances, whilst the user (30) need not enter such details themselves, the user (30) may be requested to verify any automatically populated details.

It will be appreciated that the security measures (70) such as, for example, the use of a safe or other enclosure, installation of security doors, security cameras and alarms, security personnel and guard-dogs, etc, all contribute to reducing the risk of theft and hence may reduce the amount that is likely to be required in respect of an insurance claim. Therefore, it is desirable that such information is disclosed to the insurer (80) as soon as possible prior to (eg. if the policy requires same) or following an instance of loss, damage or theft. Recommendations in the form of advice/notifications may be generated with respect to improving security measures for items of value particularly where the value of those items increases over time and the originally advised security measures may be considered either less than adequate or warrant upgrading. Artificial intelligence techniques may be utilised in this regard, including to evaluate the efficacy of existing security measures and protocols and generate recommendations for enhancements. Further, such techniques may be utilised to estimate the effect of security improvements on insurance rates using predictive analytics and provide same to users.

It is to be also understood that whilst an example is shown in FIG. 4 in which the asset (60) is a watch, the assets (60) may include anything of value to the user, including, but not limited to, collectables and antiques, jewelry, paintings, sculptures, ceramics, period furniture, clocks, books, maps, stamps, rugs, tapestries, deeds, etc. For any items that may be custom-made and/or are antique items, a more detailed description may be requested in order to clearly distinguish why the item is considered to be an item of value (eg. its provenance).

In the event that a user (30) is not able to respond to particular prompts at the time of registering their assets (30), the interface (170) may automatically generate additional queries and it is to be understood that the level of enquiry through interface (170) may be based upon satisfying a minimum information score. For example, different types of information may have a particular score associated therewith, wherein based upon receipt of particular information a total score is calculated reflective of the quantity and/or quality of information provided by the user (30) in relation to their asset (60). In the event that the total score does not satisfy a minimum threshold score, then the user (30) may be requested to provide additional information and in that regard, additional queries may be generated through interface (170) for presentation to the user (30).

The same may occur when the user (30) is not able to provide answers to particular prompts either because such information is not available or they may not recall such information. In this regard, additional assistance may be provided to the user (30) via the platform. For example, if the user (30) uploads a photo or image of their asset (60), then the system may automatically scan the photo or image and utilise a suitable network (such as the internet) to conduct searches with respect to the item in an effort to locate further details regarding the item according to visual matches with respect to other items detailed in online data repositories, with a view to populating any missing data query fields which the user (30) was unable to populate.

FIG. 5 shows in greater detail Segment 500 of FIG. 1 and, in particular, a further example interface (180) in the form of an insurance provider selection/quotation/payment interface. Based on the user (30) submitting sufficient information, details and/or documentation relating to their asset (60), interface (180) is displayed in which a listing of available insurance providers (80) may be presented. As previously described, a full listing (network) of insurance providers (80) may be provided requiring the user (30) to scroll through and select a provider (80) based upon their displayed profiles, or alternatively, a subset of all registered insurance providers (80) may be listed wherein the subset is automatically selected based upon particular attributes of the user (30) and/or of the asset (60) and/or the provider (80). In one example, only those insurance providers (80) who are located within a pre-determined vicinity of the location (75) of the asset (60) are listed.

However, the selected subset of providers (80) may be based upon additional attributes other than solely the location (75) of assets (60). In another example, there may be insurance providers (80) who specialize in particular types of assets and this may also be taken into account when displaying a list of providers for selection. Any additional filters selected by the user (30), including in relation to the value of the asset (60) and other preferences of the user (30) insofar as their particular insurance claim is concerned may also be used to influence the list of providers (80) presented to the user (30). Based upon the selection of a particular insurance provider (80), the interface (180) may enable the user (30) to proceed to a quotation and payment process (85) in which a quotation is requested and received from the selected insurance provider (80). Based upon acceptance of the quotation from the user (30), the user (30) may be invited to attend to payment (88) to the insurance provider (80) in respect of the quotation using the software application (40).

FIG. 6 shows in greater detail Segment 600 of FIG. 1 and, in particular, a further interface (190) that enables similar information previously transmitted to an insurance provider (80) to be transmitted to a law enforcement agency (90) (noting that the transmission of such information may occur sequentially or simultaneously) in view of stolen assets (60). When sending details relating to a stolen asset (60) to a law enforcement agency (90), the user (30) may also be prompted through user interface (190) to provide details relating to the particular circumstances relating to the theft including the location at which the theft occurred, details regarding any interaction with the thief, whether any additional details relating to the theft or thief are available, etc. Such additional information may be packaged together with the existing information/profile relating to the user (30) and the asset(s) (60), and transmitted to the law enforcement agency (90) who will create a report and proceed with their usual practice of seeking recovery of stolen items. In a preferred embodiment that utilizes a combination of document scanning techniques and image recognition methods, the scanning and image recognition/extraction from various documents relevant to assets (60) owned by the user (30) is initially used to assist the user (30) and simplify the process of uploading relevant asset information to the computer implemented network. However, the same information and image recognition/extraction is equally relevant to insurers and law enforcement agencies and hence the preferred embodiment implementation of this particular combination of techniques is also particularly useful for the provision of relevant information to law enforcement agencies when the involvement of such an agency is required

The interface (190) may also provide a communication means for the law enforcement agency (90) (and/or insurance provider (80)) to request further details and/or confirmation from the user (30) regarding each individual item of value (60) according to the details provided by the user (30).

Interface (190), and any associated interfaces not necessarily shown in FIG. 6, may be utilized by the user (30) for a number of additional purposes including in relation to updating asset details and ensuring that updated asset details are transmitted to relevant insurance providers (80) and/or law enforcement agencies (90). For example, as soon as any changes to a location, security measure, etc, associated with a particular asset (60) occur, such changes may be registered by the user (30) through the software application (40). It may be useful for such updates to be provided to at least the insurance provider (80) automatically based upon the entry of such updates using interface (190) by the user (30).

It will be appreciated that information will be received from a user at the establishment of an insurance policy, but also at regular or predetermined times during the term of the insurance policy as required by same. Such information may be in the form of updates to previously received details and information in relation to the asset(s), including any change in respect of one or more of the asset(s), the ownership of the asset(s), the value of the asset(s), the location at which the asset(s) are maintained, or the security measures at the location at which the asset(s) are maintained. One or more artificial intelligence techniques may be used to extract such updates from the information received, including based on natural language processing (NLP) and picture recognition technologies. This enables insurance providers to consider same in substantially real-time and provide feedback that the changes to the asset(s), the ownership, the value, the location and/or security measures requires a new insurance policy relating to the one or more assets, an amendment to an existing insurance policy for the one or more assets; or an amendment to the quotation.

Accordingly, it will be appreciated that it is important that insurers (80) maintain up to date information regarding assets owned by their clients and that updated details and information provided by the user (30) regarding their assets (60) and circumstances are kept up to date which will also ensure that the user (30) pays the lowest insurance premium possible. Further, this may avoid any potential cancellation or voiding of insurance policies that may arise as a result of a change in their circumstances, e.g. removal of existing security doors associated with a particular asset (60) which occur prior to making a claim through a particular insurer (80). In other words, the ability to transmit in substantially real-time any changes entered by the user (30) directly to the insurer (80) will assist to protect the user's interest. This will also avoid the need for the user (30) to separately contact their insurer (80) using, for example, electronic mail or other communication means. This therefore contributes to the technical benefit associated with the present invention with respect to conserving computer processing and networking resources required to be used in conventional methods including that which arises from the communication of changes to an insurance provider (80).

Additional details which may be updated with respect to assets (60) include the value of the asset (60). Users (30) may be provided with regular updates regarding the value of the items (60) according to their catalogue of items which may include, but is not limited to, up to date valuations regarding items within their catalogue such as jewelry, watches, precious stones, bullion, coins, paintings, sculptures, etc. Such updates may also be transmitted to the user's insurer (80), thereby keeping the insurer updated regarding any information that can affect the value of an insured asset (60). Valuation updates can either be provided by the user (30) (eg. in the event that a particular asset has been re-valued by the user using the services of a professional valuer), or may be based upon a market valuation (eg. based on the current price of gold).

In another embodiment, users may receive notifications regarding auction results with respect to items similar to those owned by the user (30). In this regard, a user (30) may establish personalized alerts regarding auction results or may be invited to receive notifications from auction houses in which items similar to those owned by the user (30) are scheduled for sale by auction. Similarly, users (30) may be invited to share auction results regarding similar items that are included in their assets (60) with their preferred insurance provider(s), such that all parties simultaneously receive up to date information regarding up to date valuations with respect to items owned by the user (30).

It will be appreciated that the abovementioned market valuations, auction results, etc, which assist in maintaining a substantially real-time value for an asset (60), may be retrieved by any suitable means including by automatically conducting online searches (which may again be according to visual matches with other items located during the online search and extracting said further details from one or more online data repositories) and utilising same to establish or update the value of the asset. Such information may also be extracted from one or more external data sources, such as the data repository associated with an auction house. Still further, such information may be determined or predicted using one or more artificial intelligence techniques. For example, artificial intelligence may be utilised to analyse auction results and market data to provide accurate valuations, and predictive analytics may be utilised to predict market value trends and patterns.

Insights may also be provided to users with respect to potential changes in value of their assets and how to maintain and/or maximise same, as discussed in greater detail below. Alerts may also be generated based on the value of an asset significantly increasing or decreasing according to such analysis.

The server (20) may automatically conduct searching in relation to particular assets and a level of maintenance that may be required in order to maintain or enhance a particular value of the asset (30). Such information may be presented to the user (30) through the interface (190) or through an associated interface in order to provide the user (30) with useful information regarding the items in their catalogue that require regular and/or infrequent maintenance in order to maintain or enhance value. In this regard, notifications may be provided to the user (30) with respect to those items that should receive maintenance at an appropriate time. One or more artificial intelligence techniques may also be utilized to predict when maintenance may be required based on historical data and usage patterns, and users can be automatically notified regarding upcoming maintenance needs and provided with detailed instructions regarding how to perform the necessary maintenance or upgrade. Additional alerts and/or notifications may be provided to the user through the software application (40) as previously described.

Interface (190) or one or more interfaces associated therewith, may also be utilised by users (30) to conduct general communications with other users (30), with their insurers (80) (eg. via a chat function), with law enforcement agents (90), etc.

A person skilled in the relevant field of technology will appreciate that the integration of artificial intelligence techniques as described above improves the platform, from assisting with processing and interpreting data received from users and other sources to predicting value trends and patterns and thereby facilitating establishing or updating the value of assets amongst other things to ensure that insurance providers, etc, are provided with the most up to date and accurate information. The techniques described will increase efficiencies and effectiveness in each process, ensuring that the platform not only meets its intended purpose but also continuously improves through learning and adaptation. Examples of artificial intelligence platforms that may be suitable for performing the artificial intelligence techniques described herein include, but are not limited to, ChatGPT and Google DeepMind

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

1. A data communications network comprising connected data communications devices and a method of operating same to facilitate the documentation of information relating to assets, the method comprising:
receiving, by one or more processors, details from each user of a plurality of users comprising verification details sufficient to establish a user account;
receiving, by one or more processors, details from each user regarding one or more assets owned by the user;
processing, by one or more processors, the details regarding one or more assets owned by the user and generating, for display on a data communications device associated with the user, prompts regarding any specific additional information required to establish or update one or more of:
a location of each asset,
security measures associated with each asset,
ownership of each asset, or
a value of each asset;
receiving, by one or more processors, additional information from the user in response to the prompts, and extracting from the received details and the additional information received in response to the prompts, the location, security measures present at the location, ownership, and value of each of the one or more assets;
transmitting, by one or more processors, the received details and additional information to an insurance provider upon receipt of an instruction from the user;
receiving, by one or more processors, details from the insurance provider comprising feedback that the one or more assets require a new insurance policy relating to the one or more assets, or an amendment to an existing insurance policy for the one or more assets, and a quotation to insure, or continue to insure, the one or more assets; and
receiving, by one or more processors, an acceptance of the quotation from the user confirming that the user considers the quotation acceptable.

2. The data communications network of claim 1, wherein the method further comprises:
transmitting, by one or more processors, the extracted details to a law enforcement agency upon receipt of an instruction from the user.

3. The data communications network of claim 1, wherein the prompts regarding any specific additional information required to establish or update one or more of the location, security measures, ownership, or value of each asset comprise a request for one or more of:
a description of each asset;
copies of purchase documents comprising one or more of invoices, receipts or warranty documents associated with each asset;
one or more images or photographs of each asset,
relevant information pertaining to each asset comprising one or more of purchase date, purchase price, and valuation details; or
supporting documents comprising one or more of a certificate of authenticity, certificate of valuation, or technical drawings associated with each asset.

4. The data communications network of claim 1, wherein the location of the one or more assets is determined:
according to the extracted details regarding the location of the one or more assets, or
in instances where the asset is carried by the user, utilising a GPS location facility associated with the user's data communications device.

5. The data communications network of claim 1, wherein the security measures present at the location of the asset comprise one or more of:
installation of security doors;
installation of security cameras;
installation of security alarms;
storage of the asset in a secure environment comprising one or more of:
on the user,
in a locked room,
in a locked cabinet, or
in a safe.

6. The data communications network of claim 1, wherein the method further comprises:
automatically determining, by one or more processors, that information received from a user represents an update to previously received details and information in relation to the asset(s), the updates comprising any change in respect of one or more of:
the asset(s),
the ownership of the asset(s);
the value of the asset(s);
the location at which the asset(s) are maintained, or
the security measures at the location at which the asset(s) are maintained.

7. The data communications network of claim 6, wherein the method further comprises:
extracting the changes to the asset(s), the ownership, the value, the location and/or the security measures, and transmitting same in substantially real-time to the insurance provider.

8. The data communications network of claim 7, wherein the method further comprises:
receiving, by one or more processors, feedback from the insurance provider that the changes to the asset(s), the ownership, the value, the location and/or security measures requires one or more of:
a new insurance policy relating to the one or more assets;
an amendment to an existing insurance policy for the one or more assets; or
an amendment to the quotation.

9. The data communications network of claim 1, wherein the one or more assets comprise items of value comprising one or more of:
custom made items;
collectables and antiques;
jewelry;
paintings;
sculptures;
ceramics;
period furniture;
clocks;
books;
maps;
stamps;
rugs; or
tapestries.

10. The data communications network of claim 9, wherein generating prompts regarding any specific additional information required to establish or update one or more of a location of each asset, security measures associated with each asset,
ownership of each asset, or a value of each asset, further comprises:
identifying that the asset represents an item of value and on that basis requesting a more detailed description from the user in support of the asset being categorised as an item of value.

11. The data communications network of claim 1, wherein in addition to using received details and additional information from the user regarding each asset to establish or update a value of the asset, the method further comprising retrieving further details relating to the one or more assets by one or more of:
conducting, by one or more processors, an online search to locate further details regarding the one or more assets according to visual matches with other items located during the online search and extracting said further details from one or more online data repositories and utilising same to establish or update the value of the asset,
retrieving, by one or more processors, further details regarding the value of the one or more assets from one or more external data sources, or
utilising, by one or more processors, one or more artificial intelligence techniques to perform predictive analytics.

12. The data communications network of claim 11, wherein said further details comprise one or more of:
a catalogue price of the same or a similar asset;
a market valuation undertaken in respect of the same or a similar asset;
a market value of material of which the asset is comprised;
online auction results in respect of the same or a similar asset;
determined or predicted value trends or patterns with respect to the same or a similar asset.

13. The data communications network of claim 11, wherein the method further comprises:
automatically transmitting, by one or more processors, the further details relating to the one or more assets to the insurance provider.

14. The data communications network of claim 1, wherein the method further comprises:
generating, by one or more processors, an interface that enables users to access a catalogue of their one or more assets comprising data relating to ownership and value of each asset, and the location of the asset(s) and security measures in place to secure the asset(s).

15. The data communications network of claim 14, wherein the method further comprises:
generating, by one or more processors, information for the user regarding those assets in the catalogue that require regular and/or infrequent maintenance to maintain or enhance the value of the asset; and
generating, by one or more processors, notifications to the user requesting that the user attend to one or more actions to maintain or enhance the value of the asset and transmitting the notifications to the user at appropriate times.

16. The data communications network of claim 14, wherein the method further comprises:
automatically providing, by one or more processors, users with regular updates regarding the value of their assets according to their catalogue of items.

17. The data communications network of claim 2, wherein the method further comprises:
providing, by one or more processors, a communication facility to enable law enforcement agencies and/or insurance providers to request confirmation regarding details received by the law enforcement agencies and/or insurance providers in respect of asset(s) owned by the user.

18. The data communications network of claim 1, wherein the method further comprises:
generating, by one or more processors, recommendations for the user with respect to increasing security measures for assets comprising those assets that are recognised as items whose value will increase over time, and where the current security measures are determined not to satisfy a minimum security threshold for such assets.

19. A computer-implemented method for facilitating the documentation of information relating to assets, the method comprising:
receiving, by one or more processors, details from each user of a plurality of users comprising verification details sufficient to establish a user account;
receiving, by one or more processors, details from each user regarding one or more assets owned by the user;
processing, by one or more processors, the details regarding one or more assets owned by the user and generating, for display on a data communications device associated with the user, prompts regarding any specific additional information required to establish or update one or more of:
a location of each asset,
security measures associated with each asset,
ownership of each asset, or
a value of each asset;
receiving, by one or more processors, additional information from the user in response to the prompts, and extracting from the received details and the additional information received in response to the prompts, the location, security measures present at the location, ownership, and value of each of the one or more assets;
transmitting, by one or more processors, the received details and additional information to an insurance provider upon receipt of an instruction from the user;
receiving, by one or more processors, details from the insurance provider comprising feedback that the one or more assets require a new insurance policy relating to the one or more assets, or an amendment to an existing insurance policy for the one or more assets, and a quotation to insure, or continue to insure, the one or more assets; and
receiving, by one or more processors, an acceptance of the quotation from the user confirming that the user considers the quotation acceptable.

20. A non-transitory computer-readable medium comprising computer instruction code that, when executed on a computer, causes one or more processors of the computer to perform the steps of:
receiving details from each user of a plurality of users comprising verification details sufficient to establish a user account;
receiving details from each user regarding one or more assets owned by the user;
processing the details regarding one or more assets owned by the user and generating, for display on a data communications device associated with the user, prompts regarding any specific additional information required to establish or update one or more of:
a location of each asset,
security measures associated with each asset,
ownership of each asset, or
a value of each asset;
receiving additional information from the user in response to the prompts, and extracting from the received details and the additional information received in response to the prompts, the location, security measures present at the location, ownership, and value of each of the one or more assets;
transmitting the received details and additional information to an insurance provider upon receipt of an instruction from the user;
receiving details from the insurance provider comprising feedback that the one or more assets require a new insurance policy relating to the one or more assets, or an amendment to an existing insurance policy for the one or more assets, and a quotation to insure, or continue to insure, the one or more assets; and
receiving an acceptance of the quotation from the user confirming that the user considers the quotation acceptable.
